(19) United States
(12) Patent Application Publication
(10) Pub. No.: US 2011/0022938 A1
(43) Pub. Date: Jan. 27, 2011

(54) APPARATUS, METHOD AND SYSTEM FOR MODIFYING PAGES

(76) Inventors: Dennis WILKINSON, Los Altos, CA (US); William Hertling, Portland, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/508,254

(22) Filed: Jul. 23, 2009

(51) Int. Cl. G06F 15/173; G06F 17/00

(52) U.S. Cl. 715/205; 715/234; 709/224

(57) ABSTRACT

According to one embodiment of the present invention, there is provided a method of determining, for a first web page in a set of web pages comprising a web site, one or more further web pages from the set of web pages to be identified in the first web page. The method comprises analyzing a log of web pages previously requested from the web site to determine one or more further web pages of the web site to be identified in the first web page, and modifying the first web page to identify the one or more determined further pages.

### BACKGROUND

A web site may be generally considered to be a collection of related web pages accessible through a web server. By web page is meant a document or file in any format suitable for being viewed or accessed by a web browser application. To navigate through the web site, each web page typically includes one or more hyperlinks that, when clicked upon by a user viewing a web page through a web browser application, cause the web browser to send a request to the web server to retrieve a further web page identified in the hyperlink.

Typically, hyperlinks are inserted manually into each web page by the designer of the web site. The designer thus determines the manner in which web browser users navigate between different pages of the web site.

However, web browser users often find it difficult to locate useful information within a web site. This problem may arise, for example, through inappropriate design of the web site, or where web sites have a large number of web pages. The problem may also arise when a web site is updated frequently, or if maintained by many different groups, with each group being responsible for a different aspect of the web site. The value of a website, however, is closely linked to the ease in which users can find the information they are looking for.

### SUMMARY

According to one aspect of embodiments of the present invention, there is provided a method of determining, for a first web page in a set of web pages. comprising a web site, one or more further web pages from the set of web pages to be identified in the first web page. The method comprises analyzing a log of web pages previously requested from the web site to determine one or more further web pages of the web site to be identified in the first web page, and modifying the first web page to identify the one or more determined further pages.

According to a second aspect of embodiments of the present invention there is provided apparatus for including, in a web page from a set of web pages, hyperlinks to one or more further pages from the set of web pages. The apparatus comprises an analyzer for analyzing a log of web pages previously requested from the set of web pages to identify one or more further web pages from the set of web pages, and a processing element for modifying the first web page to include a hyperlink to each of the one or more identified further web pages.

According to a third aspect of embodiments of the present invention, there is provided a system for inserting hyperlinks into a web page from a set of web pages of a web site, the hyperlinks being to one or more further pages from the set of web pages. The system comprises a web server for receiving requests for a web page and for sending the requested web page to the requestor, the web server further configured to store log data relating to the requested pages in a click-stream log store, an analyzer for analyzing the stored log data to identify one or more further web pages from the set of web pages, and a processor element for modifying a first web page to include a hyperlink to each of the one or more identified further web pages.

### BRIEF DESCRIPTION

Embodiments of the invention will now be described, by way of non-limiting example only, with reference to the accompanying drawings, in which:

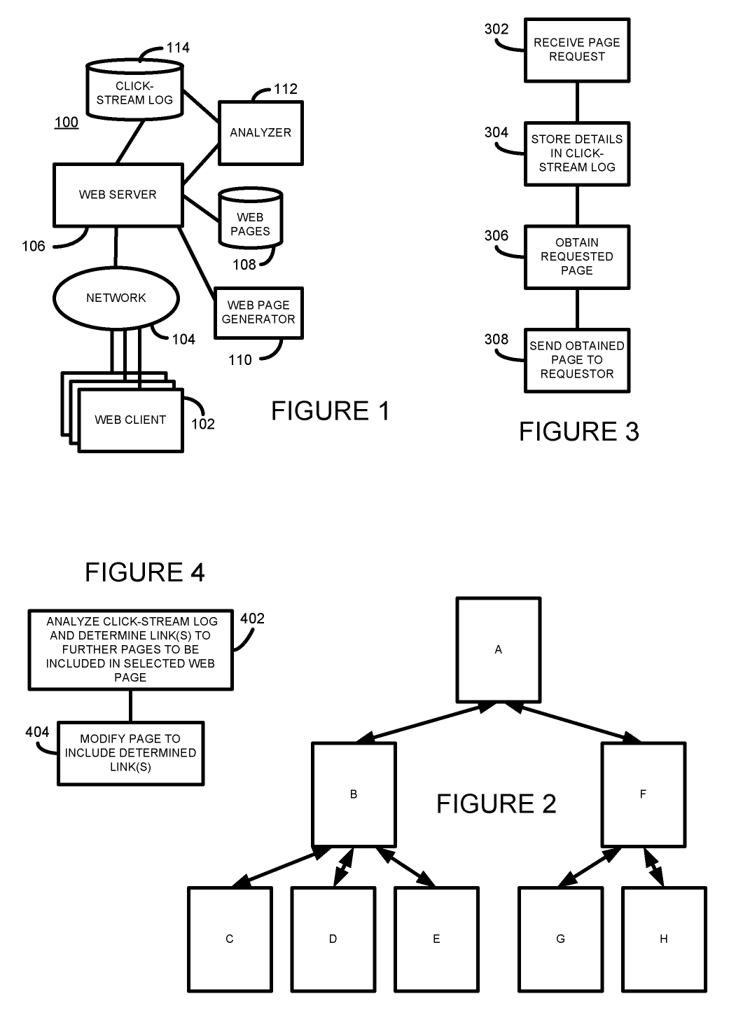

FIG. 1 is a block diagram showing a system according to an embodiment of the present invention;

FIG. 2 is block diagram outlining the relationship of pages of an example web site;

FIG. 3 is flow diagram outlining example processing steps according to an embodiment of the present invention;

FIG. 4 is a flow diagram outlining example processing steps according to an embodiment of the present invention;

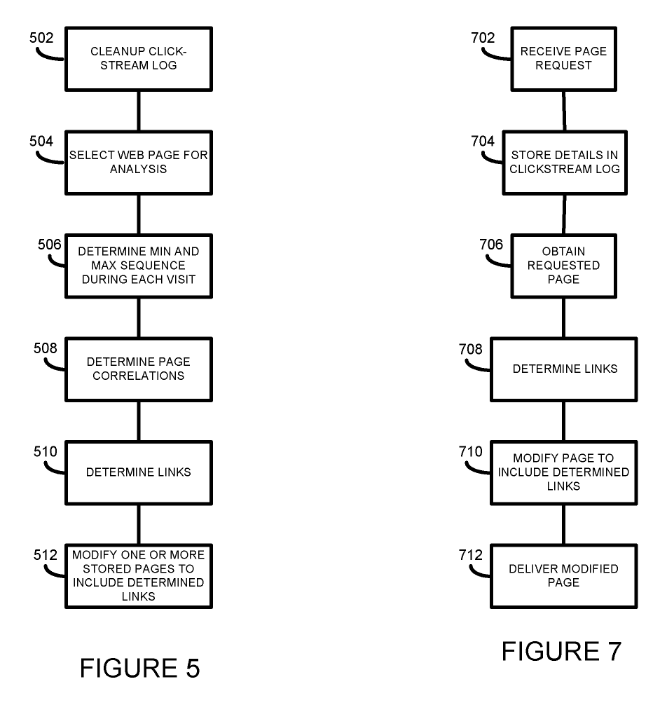

FIG. 5 is a flow diagram outlining example processing steps according to an embodiment of the present invention;

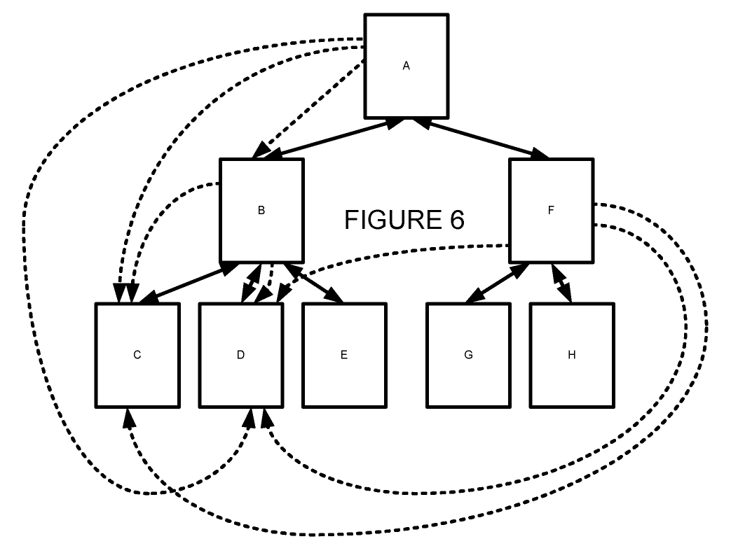

FIG. 6 is a block diagram outlining the relationship of pages of a web site according to an embodiment of the present invention; and

FIG. 7 is a flow diagram outlining example processing steps according to an embodiment of the present invention.

### DETAILED DESCRIPTION

To assist users of web browsers in finding particular information easily it is known to automatically insert hyperlinks into web pages before sending them to a user device. For example, many e-commerce web sites automatically insert, into a requested web page, hyperlinks to further web pages describing other products that people having purchased a product described on the requested web page have also purchased. For such systems to work, however, the system has to understand the content of the requested page (for example, to which product it relates), as well to have access to a transaction database to determine which other products people purchasing the product described on the requested web page have also purchased. This requires a close coupling of the web server and the transaction database, which is often either undesirable or not feasible.

Furthermore, such systems rely on distinct events, such as purchases, where there is no or little ambiguity as to what the user was intending to do. For example, if a user makes a purchase it can strongly implied that the user is highly interested in the purchased product.

Referring now to FIG. 1, there is shown a system 100 according to an embodiment of the present invention. Additional reference is made to the flow diagrams of FIGS. 2 and 3.

A web server 106 receives (step 302) requests from one or more web clients 102 to serve a web page identified in the request to the web client 102 who requested it. The web server 106 may be, for example, a suitable computing device having a processor and configured to operate, for example by way of an appropriate computer program, as a web server. Typically, the web clients 102 access the web server 106 through a network 104 such as the Internet or a private intranet network. The web client may comprise, for example, a suitable computing device running a suitable web browser application. The web server 106 provides access to a set of web pages stored either in a storage device 108 or generated dynamically by a web page generator 110.

When the web server 106 receives a request for a web page it stores (step 304) details, or a so-called ‘click-stream’, of the requested page in a click-stream log 114. The click-stream log 114 is stored in a suitable storage device. The stored details are grouped together into an identifiable visit. By ‘visit’ is meant a period of time over which a particular web client 102 makes one or more requests for web pages from the web server 108. A visit is considered terminated once a predetermined amount of time has elapsed since receiving a web page request from a web client 102.

In various embodiments the web server 106 may identify a visit by allocating a visit identifier to the visit by a particular web client 102. The visit identifier may be, for example, an identifier of the web client 102, such as a cookie identifier, or may be an anonymized identifier that substantially uniquely identifies the visit.

The details stored in the click-stream log 114 may include, for instance, the URL of the requested web page, the URL of the previously requested web page, the time the request was received, the URL of the web page navigated to subsequently (if any and if available), the sequence number(s) of the web page within the visit, estimated time spent viewing a requested web page (e.g. the length of time between requesting a first web page and navigating to a second web page, and the like.

Once the details of the requested web page have been stored in the click-stream log 114 the requested web page is obtained (step 306) by the web server 106 either from the web page store 108 or from a web page generator 110. The obtained web page is then sent (step 308) to the web client 102 having made the initial request.

Referring now to FIG. 2, there is shown the relationship between different web pages A, B, C, D, E, F, G, and H of an example web site, The web pages are stored in the storage device 108. Each web page has one or more clickable hyperlinks that, when clicked upon by a user, cause the web client 102 viewing the web page to send a request to retrieve a further web page identified in the clicked hyperlink. Page A is the designated ‘home page’ of the web site.

In the following discussion the nomenclature (P₁, P₂) is used to describe a pair of web pages, where P₁ denotes a first web page viewed and P₂ denotes the web page subsequently navigated to from the first web page.

As different web clients 102 visit the web pages served by the web server 106, the click-stream log 114 is updated and stored, for example in tabular form, as shown below in Table 1.

TABLE 1
EXAMPLE CLICK-STREAM LOG

| | | TIME SPENT | | |
|---|---|---|---|---|
| | | VIEWING | | |
| | | REQUESTED | | |
| | SEQUENCE | PAGE (secs) | | |
| PAGE PAIR | IN | 0 = not | | VISIT |
| (P₁, P₂) | VISIT | determined | VISIT ID | DATE |
| A, B | 1 | 21 s | 01 | Jan. 6, 2009 |
| B, C | 2 | 32 s | 01 | Jan. 6, 2009 |
| C, B | 3 | 15 s | 01 | Jan. 6, 2009 |
| B, E | 4 | 16 s | 01 | Jan. 6, 2009 |
| B, D | 5 | 26 s | 01 | Jan. 6, 2009 |
| D, — | 6 | 0 | 01 | Jan. 6, 2009 |
| A, F | 1 | 24 s | 02 | Feb. 6, 2009 |
| F, G | 2 | 19 s | 02 | Feb. 6, 2009 |
| G, F | 3 | 5 s | 02 | Feb. 6, 2009 |
| F, A | 4 | 4 s | 02 | Feb. 6, 2009 |
| A, B | 5 | 32 s | 02 | Feb. 6, 2009 |
| B, C | 6 | 20 s | 02 | Feb. 6, 2009 |
| C, B | 7 | 10 s | 02 | Feb. 6, 2009 |
| B, D | 8 | 20 s | 02 | Feb. 6, 2009 |
| D, — | 9 | 0 | 02 | Feb. 6, 2009 |
| A, B | 1 | 35 s | 03 | Jul. 6, 2009 |
| B, E | 2 | 45 s | 03 | Jul. 6, 2009 |
| E, B | 3 | 17 s | 03 | Jul. 6, 2009 |
| B, D | 4 | 22 s | 03 | Jul. 6, 2009 |
| D, — | 5 | 0 | 03 | Jul. 6, 2009 |

Once a sufficient number of entries have been made in the click-stream log 114, a click-stream log analyzer module 112 is used to analyze (step 402) the click-stream log 114 and to determine, for a selected web page of the web site, one or more links to further web pages of the web site to be inserted into the selected web page. The selected web page is then modified (step 404) to include the one or more determined links. The analyzer module 112 may, for example, be implemented on the web server 106, or may be implemented on a separate computing device having a processor and configured by way of appropriate programming instructions.

It should be noted that, advantageously, in embodiments described below the determination of the link or links to be inserted into a given web page is made only from an analysis of the click-stream log 114, as described in greater detail below. The aim of the analysis is to determine the web pages of the web site that are potentially the most useful or relevant to users browsing the web site. Advantageously this is achieved without any knowledge of the content of any web pages and without access or coupling to a transaction database, allowing the techniques described herein to be applied to any web site.

The analysis may, for example, attempt to determine the browsing paths that users take within a visit to the web site, and infer ‘useful’ paths from those browsing paths in an attempt to help future visitors follow the inferred ‘useful’ paths by inserting appropriate links into appropriate web pages of the web site. This is achieved through appropriate analysis of the click-stream log 114. In different embodiments the analysis may be any appropriate statistical, mathematical, relationship, or logical analysis.

Referring now to FIG. 5, there is shown a flow diagram outlining example processing steps taken by the analyzer module 112 according to an embodiment of the present invention.

At step 502 the stored click-stream log 114 is processed to discount any non-useful data. This may be achieved, for example, by deleting any such data from the click-stream log 114, or by adding a flag to indicate either whether the data is deemed useful or non-useful.

In an alternative embodiment the step of cleaning up the browser history may be avoided by having the web server 114 only store deemed useful data in the click-stream log 114, or by having the web server 114 delete any such non-useful data at the end of each visit.

Non-useful data may be considered as any data which is not useful in determining one or more links to further web pages to be inserted into a current web page. This may include, for example, a visit in which only a single web page was viewed. A visit in which more than a predetermined number of web pages were viewed (for example, greater than 15 to 25 pages depending on the type of web site) may also be considered non-useful as such a visit may have been generated by an automatic web crawler or robot application and thus may not be representative of a human user visit. A web page visited for less than a predetermined amount of time (for example, less than 10 seconds, although this will depend on the type or amount of content of a particular web page) may also be considered to be non-useful. A web page viewed during a visit prior to a predetermined date may also be considered non-useful since it may be deemed that the visit occurred to long ago to be useful, although again this will depend on the nature of the web site.

In the following discussion reference to a web page implies a deemed useful web page.

Each web page visited during a visit is selected (step 504) and the click-stream log 114 is analyzed to determine (step 506) the minimum and maximum sequence within the visits, as shown below in Table 2.

TABLE 2

| P₁ Page ID | Visit ID | Min Seq | Max Seq |
|---|---|---|---|
| A | 1 | 1 | 1 |
| B | 1 | 2 | 5 |
| C | 1 | 3 | 3 |
| D | 1 | 6 | 6 (last) |
| A | 2 | 1 | 5 |
| B | 2 | 6 | 8 |
| C | 2 | 7 | 7 |
| D | 2 | 9 | 9 (last) |
| F | 2 | 2 | 4 |
| G | 2 | 3 | 3 |
| A | 3 | 1 | 1 |
| B | 3 | 2 | 4 |
| E | 3 | 3 | 3 |
| D | 3 | 5 | 5 (last) |

A table of correlations is then created (step 508) and stored, for example in table form, for each pair of pages in the web site, as shown below in Table 3.

For page pairs in which the P₂ navigated to was the last page visited during the visit are given a correlation value of 1.0

For page pairs in which the P₂ navigated to was not the last page visited during the visit are given a correlation value of 0.33.

It should be noted that other correlation values may assigned depending on particular circumstances, such as the number of web pages in the website, the number of entries in the click-stream log, etc.

For example, during the visit having the visit ID 1 it can be seen from Table 1 that page A was visited followed by page B. From Table 2 it can be seen that page B was not the last page visited during the visit, hence the assigned correlation value of the page pair ‘A’ to ‘B’ is given a correlation value of 0.33.

TABLE 3

| PAGE PAIR (P₁, P₂) | CORRELATION | VISIT ID |
|---|---|---|
| A, B | 0.33 | 1 |
| B, C | 0.33 | 1 |
| C, B | 0.33 | 1 |
| B, E | 0.33 | 1 |
| B, D | 1.0 | 1 |
| A, F | 0.33 | 2 |
| F, G | 0.33 | 2 |
| G, F | 0.33 | 2 |
| F, A | 0.33 | 2 |
| A, B | 0.33 | 2 |
| B, C | 0.33 | 2 |
| C, B | 0.33 | 2 |
| B, D | 1.0 | 2 |
| A, B | 0.33 | 3 |
| B, E | 0.33 | 3 |
| E, B | 0.33 | 3 |
| B, D | 1.0 | 3 |

Once a correlation value for each page pair has been allocated, the total correlation score for each page pair for all visits is calculated (step 508), as shown in Table 4 below.

TABLE 4

| PAGE PAIR (P₁, P₂) | CORRELATION |
|---|---|
| A, B | 0.66 |
| A, F | 0.33 |
| B, C | 0.66 |
| B, D | 3.0 |
| B, E | 0.66 |
| C, B | 0.66 |
| E, B | 0.33 |
| F, A | 0.33 |
| F, G | 0.33 |
| G, F | 0.33 |

At step 510 one or more links to further web pages are determined using the total correlation values for each page pair. For example, in the present embodiment it is assumed that the P₂ of the page pairs having the highest total correlation value can be assumed to be the web page(s) most frequently navigated to at the end of each individual visit. This is based on the further assumption that the last page visited is the page containing the information sought by the user.

From Table 4, it can be seen that the page pair (B, D) has a correlation score of 3.0, and page pairs (A, B), (B, C), (B, E), and (C, B) have correlation scores of 0.66. From this it can be inferred that page D is the web page most likely to be of most relevance or interest to a user. Page B is likely to be the next most relevant or useful page since page B is the P₂ in page pairs (A, B) and (C, B) (total correlation value for page B as P₂ being 1.66), followed by pages C and E both having a total correlation value of 0.66.

In the present embodiment up to a predetermined maximum number of determined links are selected for inclusion in one or more web pages of the web site.

For example, web page A may be modified (step 512) to have the top three determined links included therein. In the present example, this would be links to pages D (total correlation value or 3.0), B (total correlation value of 1.66), and C (total correlation value of 0.66).

If the web page correlation value fails to meet a predetermined minimum threshold, links to less than the predetermined maximum number of determined links may be selected for inclusion.

The number of web pages to be modified to include one or more determined links may vary from, for example, just the home page (i.e. page A in the present example), the first level pages directly linked to from the home page, up to all of the web pages in the web site, depending on particular requirements. Individual web pages may be excluded from being modified based, for example, on attributes of the web page such as web page name, URL, last modification date, etc., or based on meta-data stored in or associated with a web page.

The modifications may be made, for example, be obtaining a stored web page from the web page store 108, inserting the determined links in an appropriate location within the obtained web page, and storing the modified web page in the web page store 108. Where the pages to be modified are dynamically generated, the determined links to be inserted may be sent to the web page generator 110 which then includes the determined links into a dynamically generated web page prior to sending the web page to the requestor.

FIG. 6, for example, shows the web site of FIG. 2 in which determined links having been inserted into all level 1 and level 2 web pages. The inserted links are shown by dotted lines. Advantageously, it can be seen that direct links to pages D, C, and B have been inserted into page F, offering users a direct link to those pages likely to be of most relevance or interest to users.

In further embodiments additional information may be collected in the click-stream log 114, or determined or derived from the click-stream log 114, for analysis by the analyzer 112. The analysis of such additional information may be used in the calculation of the correlation value, or used to calculate a confidence level value for each determined link.

For example, where the additional information includes the total estimated viewing time of each page a confidence level value may be determined proportional to the amount of time a particular page was viewed. For example, the web pages of the web site having the highest determined viewing time may be inferred to have a high usefulness or user relevance value, and hence be allocated a high confidence level value. Conversely, web pages having the lowest determined viewing time may be inferred to have a low usefulness or user relevance value, and be allocated a low confidence level value.

Where the additional information includes the total number of page visits, web pages having the highest number of visits may be inferred to have a high usefulness or user relevance value, and hence be allocated a high confidence level value, with the web pages having the lowest total number of page visits being allocated a low confidence level value.

Where the additional information includes the total number of web pages viewed within each visit, varying confidence level values may be allocated to each page depending their individual page sequence ID.

The total correlation value and confidence level values are then used to determine which links should be included in a modified web page and the order in which the determined links are displayed in the modified web page. Different weighting may be applied to the correlation values and different confidence level values to determine an overall correlation and/or confidence value. To assist users in determining how relevant an inserted link may be the calculated confidence level may be displayed to the user in proximity to the inserted link.

In a further embodiment one or more web pages may be designated as having a zero or negative correlation value or weight. For example, a web page that contains company contact or help information may be considered to be undesirable destination within the web site, since it may be implied that a user browsing to such a page has been unable to find the information they were looking for in the web site. For example, in the above example, if page E were a company contact information or assistance web page, the correlation value allocated to a page pair where P₂ is page E may be given a value of zero or −1. This would then help prevent links to page E from being inserted into other web pages.

In a yet further embodiment, the analyzer 112 may additionally take into customer satisfaction data stored separately from the click-stream log 114. For instance, some web pages may include a link or code that enables a user to give a rating as to the perceived usefulness of the web page. The correlation value or confidence level value assigned to each page pair may then be adjusted based on the average user rating of the particular page.

Different correlation values or weightings may be applied to different data in the click-stream log 114 or in different associated data, such as user ratings.

Depending on various factors, such as the number of web pages in the web site, the number of visitors, the frequency at which the content of the web site is updated, etc, it may be useful to re-run the above-described process to re-determine the relevant links and to update the stored web pages accordingly. The more visitors that visit the web site, the more accurate the determination of relevant web pages should become. After a significant update of content or layout of the web site it may suitable to only use useful data having a visit date after the update.

In a yet further embodiment the determination of relevant links is done ‘on-the-fly’, in substantially real-time, when a web page is requested, as outlined in the example flow diagram of FIG. 7.

At step 702 the web server 106 receives a request for a web page from a web client 102. The details of the requested web page are stored (step 704), as previously described, in the click-stream log 114. The web server 106 then obtains (step 706) the requested web page either from the web page store 108 or from the dynamic page generator 110. The analyzer module 112 then determines (step 708) one or more links using the stored click-stream log, as described above. The web server then modifies (step 710) the obtained requested web page to include the determined links before delivering (step 712) the modified requested web page to the requesting web client.

Although the above-described embodiments have been described primarily in relation to web pages and web sites, it will be appreciate that these examples are strictly non-limiting. For example, further embodiments can be envisaged for use in other document systems using hyperlinks to identify other documents with the system.

It will be further appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A method of determining, for a first web page in a set of web pages comprising a web site, one or more further web pages from the set of web pages to be identified in the first web page, the method comprising:
analyzing, by a processor, a log of web pages previously requested from the web site to determine one or more further web pages of the web site to be identified in the first web page; and
modifying, by the processor, the first web page to identify the one or more determined further pages.

2. The method of claim 1, wherein the log of web pages comprises click-stream data relating to web pages previously requested during one or more identifiable visits to the web site by one or more web browser applications.

3. The method of claim 1, wherein the step of analyzing comprises analyzing the log to identify one or more further web pages inferred as being relevant or useful web pages of the web site.

4. The method of claim 1, wherein the step of modifying comprises inserting a hyperlink to the determined one or more further web pages into the first web page.

5. The method of claim 1, wherein the step of analyzing comprises analyzing data in the log deemed useful data.

6. The method of claim 1, further comprising calculating, by the processor, a confidence level for each determined web page, and wherein the step of modifying further comprises identifying, by the processor, one or more determine further pages having a calculated confidence level above a predetermined threshold.

7. The method of claim 1, wherein the step of modifying further comprises modifying multiple web pages of the web site to identify the one or more determined further pages.

8. The method of claim 3, wherein the deemed useful data relates to any one of: a web page having an estimated viewing time greater than a predetermined threshold; a web page having been requested after a predetermined date; a web page not identified as being an undesirable destination in the web site; and a web page not having predetermined metadata associated therewith.

9. The method of claim 1, wherein the first web page is a web page identified in a request for a web page received by a web server, and wherein the first web page is modified prior to being sent to the requestor.

10. Apparatus for including, in a web page from a set of web pages, hyperlinks to one or more further pages from the set of web pages, comprising:
an analyzer for analyzing a log of web pages previously requested from the set of web pages to identify one or more further web pages from the set of web pages; and
a processing element for modifying the first web page to include a hyperlink to each of the one or more identified further web pages.

11. The apparatus of claim 10, wherein the analyzer is configured to analyze a log of web pages comprising click-stream data relating to web pages previously requested during one or more identifiable visits to the web site by one or more web browser applications.

12. The apparatus of claim 11, wherein analyzer is configured to analyze to the log to infer one or more further web pages as being relevant or useful web pages.

13. The apparatus of claim 11, wherein the analyzer is configured to analyze data in the log deemed useful data, the deemed useful data relating to any one of: a web page having an estimated viewing time greater than a predetermined threshold; a web page having been requested after a predetermined date; a web page not identified as being an undesirable destination in the web site; and a web page not having predetermined metadata associated therewith.

14. The apparatus of claim 11, further comprising a calculating module for calculating a confidence level for each determined web page and further configured to modify the first web page to include hyperlinks to identified further web pages having a calculated confidence level above a predetermined threshold.

15. The apparatus of claim 11, further configured to modify multiple web pages of the set of web pages.

16. The apparatus of claim 11, wherein the first web page is a web page identified in a request for a web page received by a web server, the apparatus configured to analyze the log, modify the requested web page in substantially real-time, and cause the modified web page to be sent to the requestor via the web server.

17. A system for inserting hyperlinks into a web page from a set of web pages of a web site, the hyperlinks being to one or more further pages from the set of web pages, comprising:
a web server for receiving requests for a web page and for sending the requested web page to the requestor, the web server further configured to store log data relating to the requested pages in a click-stream log store;
an analyzer for analyzing the stored log data to identify one or more further web pages from the set of web pages; and
a processor element for modifying a first web page to include a hyperlink to each of the one or more identified further web pages.

18. The system of claim 18, wherein the web server is configured to send the modified web page to the requestor of the page.

19. The system of claim 17, wherein the web server is configured to store only deemed useful data in the click-stream log store, the deemed useful data relating to any one of: a web page having an estimated viewing time greater than a predetermined threshold; a web page having been requested after a predetermined date; a web page not identified as being an undesirable destination in the web site; and a web page not having predetermined metadata associated therewith.

20. A carrier carrying computer-implementable instructions that, when interpreted by a computer, cause the computer to perform the method of claim 1.
